(19) United States
(12) Patent Application Publication
(10) Pub. No.: US 2024/0327106 A1
(43) Pub. Date: Oct. 3, 2024

(54) Lightweight Barrier Structure and Multi-Layer Film for Beverage Pod

(71) Applicant: Tekni-Plex, Inc., Wayne, PA (US)

(72) Inventors: Guangda Shi, Perrysburg, OH (US); Joe Olsavsky, Waterville, OH (US)

(21) Appl. No.: 18/623,194

(22) Filed: Apr. 1, 2024

Related U.S. Application Data
(60) Provisional application No. 63/456,543, filed on Apr. 3, 2023.

(51) Int. Cl. B65D 85/804; B65D 65/40

(52) U.S. Cl. CPC B65D 85/8043; B65D 65/40

(57) ABSTRACT

A thermoformed plastic beverage pod base and method of forming, the pod base being configured for use in a single-serve brewing machine wherein the pod base is filled with a beverage extract and sealed with a lid prior to insertion into the machine. The pod base is made from a multi-layer film that includes one or more layers of a foamed regrind polymer (e.g., polypropylene (PP) based material. The foamed material provides a desired reduction in weight, while preserving barrier function, recyclability and mechanical performance.

### FIELD OF THE INVENTION

The present invention relates to barrier films for food packaging, and in particular to a multi-layer film that provides an improved lightweight barrier structure in a beverage pod, such as a coffee pod configured for use in a single-serve brewing machine.

### BACKGROUND

Single-serve brewing machines that utilize a pod to deliver each serving are in wide-spread use today. The machines were introduced in the 1990s for use with a single-serve coffee pod but have now expanded to include pods for brewing tea, hot chocolate and cappuccino. These machines and pods provide convenience and speed, avoiding the problem of a having to make a full pot of brewed coffee which sits and grows bitter, dense and stale over time.

While quick and convenient to use, providing a pod that has an extended shelf life, with good barrier properties, is essential as coffee is prone to degrade if exposed to oxygen and/or moisture. The pod must also provide mechanical rigidity, to withstand both filling of the pod, sealing with a lid, storage and shipment, and finally insertion and use in the machine which includes being punctured by hollow needles that allow heated water to enter the pod, brewing within the pod, and delivery of the brewed beverage from the pod into a beverage cup. Furthermore, the pods are preferably recyclable in an established recycle stream.

It would be desirable to provide an improved barrier structure for such beverage pods, ideally one that uses less material (resulting in weight reduction and material cost savings) while delivering the required mechanical and barrier performance.

### SUMMARY OF THE INVENTION

The present invention is designed to reduce the weight of a plastic beverage pod base configured for use in a single-serve brewing machine wherein the pod base is filled a beverage extract and sealed with a lid prior to insertion into the machine. The weight reduction reduces the environmental impact, while still allowing use of multi-layer material for making the pod bases. Selective foaming of the regrind layer provides a weight reduction of for example, 5 to 15% compared to a pod base wall of the same thickness without foaming, while maintaining the performance characteristics of the entire pod base (barrier and mechanical properties). Optionally the used pod bases can be reground and reused to make further pod bases (recycled). As noted, the reduction in weight can be achieved without a significant reduction in mechanical properties.

In accordance with various embodiments of the present invention, a thermoformed plastic beverage pod base is provided that includes at least one interior layer of a foamed regrind polymer-based material. The foamed regrind material provides a desired reduction in weight. However, the foamed material layer must be separated from a barrier layer, to avoid compromising the performance of the barrier material. The barrier is typically an oxygen barrier material; it may also provide a barrier to moisture. For example, a beverage extract such as coffee extract (coffee grounds) stored in the sealed pod is susceptible to degradation in the presence of air (oxygen) and moisture.

In accordance with various embodiments of the present invention, a thermoformed plastic beverage pod base is provided that includes one or more exterior layers (e.g., opposing inner and outer exterior layers) of thermal formable polymer (e.g., polyolefin) material, and optionally with one of more mineral fillers, such as talc or calcium carbonate. The mineral fillers are added in an amount desired to enhance the mechanical properties of the pod base, i.e., to withstand filling with a beverage extract, sealing a lid to the open top end of the base, storage, shipment and finally use in a single-serve brewing machine which includes the pod being punctured through both the lid and base with opposing hollow needles for injection of pressurized heated liquid into the pod, and delivery of the brewed beverage from the pod.

In accordance with various embodiments of the present invention, a thermoformed plastic beverage pod base is provided that includes one or more interior layers of a foamed regrind polymer-based material. The foamed regrind layer or layers collectively are preferably present in a range of from about 40% to about 60% of the total multi-layer film wall thickness (of the pod base), and preferably in a range of 45% and 55%. In one embodiment, the polymer in the regrind is factory salvage trim or sheet material from an extrusion process, and not post-consumer recycle materials that may have greater amounts of contaminants. In one embodiment, a remnant of a multi-layer sheet used to make the pod bases can be used to make the foamed regrind material. As used herein, the foamed regrind polymer-based material is formed by use of a foaming agent or gas injection.

In one embodiment of the invention, a thermoformed plastic beverage pod base configured for use in a single-serve brewing machine wherein the pod base is filled with a beverage extract and sealed with a lid prior to insertion into the machine, the pod base comprising a reduced weight multi-layer wall including: an outer surface layer of a thermal formable polymer, an inner surface layer of a thermal formable polymer, a first interior layer, disposed between the surface layers, of a barrier material, a second interior layer, disposed between the surface layers, of a foamed regrind material, and a third interior layer comprising a protective layer disposed between and separating the barrier material layer and the foamed regrind material layer, wherein the foamed regrind material is composed of a ground material comprising the materials of the multi-layer wall of the pod base, which is foamed to reduce the weight of the ground material.

In one embodiment of the invention, the foamed regrind material is formed by addition of a foaming agent or injection of gas to the ground material.

In one embodiment of the invention, the second interior layer of foamed regrind material provides a weight reduction of from 5 to 20% compared to a non-foamed regrind material layer having a same layer thickness.

In one embodiment of the invention, the outer and inner surface layers include a mineral filler that enhances the mechanical properties of the outer and inner surface layers.

In one embodiment of the invention, the mineral filler and foamed regrind material provide the pod base with a density of less than 1 gram per cubic centimeter.

In one embodiment of the invention, the thermal formable polymer comprises polyolefin, polyester or polystyrene polymer.

In one embodiment of the invention, the polyolefin polymer comprises polypropylene or high-density polyethylene.

In one embodiment of the invention, the thermal formable polymer comprises polypropylene.

In one embodiment of the invention, the mineral filler comprises at least one of talc and calcium carbonate.

In one embodiment of the invention, the barrier material is an oxygen barrier material.

In one embodiment of the invention, the oxygen barrier material comprises ethylene vinyl alcohol (EVOH).

In one embodiment of the invention, the multi-layer wall includes:

a fourth interior layer disposed between and separating the second interior layer and one of the outer or inner surface layers.

In one embodiment of the invention, the third and fourth interior layers are tie layers.

In another embodiment of the invention, a method of forming a thermoformed plastic beverage pod base configured for use in a single-serve brewing machine wherein the pod base is filled with a beverage extract and sealed with a lid prior to insertion into the machine, the pod base comprising a reduced weight multi-layer wall including:
an outer surface layer of a thermal formable polymer,
an inner surface layer of a thermal formable polymer,
a first interior layer, disposed between the surface layers, of a barrier material,
a second interior layer, disposed between the surface layers, of a foamed regrind material, and
a third interior layer comprising a protective layer disposed between and separating the barrier material layer and the foamed regrind material layer,
wherein the method includes steps of:
providing a sheet having the multi-layer wall of the pod base,
producing a plurality of pod bases from the sheet to form a remnant sheet,
grinding and foaming the remnant sheet to form the foamed regrind material, and
forming a subsequent sheet, for producing a plurality of pod bases, having the multi-layer wall of the pod base using the foamed regrind material as the second interior layer.

In another embodiment of the invention, the method includes adding previously formed pod bases having the multi-layer wall to the grinding and foaming step.

In another embodiment of the invention:
the outer surface layer of the thermal formable polymer comprises from 10 to 25 percent of the total wall thickness of the pod base,
the inner surface layer of the thermal formable polymer comprises from 10 to 25 percent of the total wall thickness of the pod base,
the first interior layer of the barrier material comprises from 1 to 3 percent of the total wall thickness of the pod base,
the second interior layer of the foamed regrind material comprises from 40 to 60 percent of the total wall thickness of the pod base, and
the third interior layer separating the barrier material layer and the foamed regrind material layer comprises from 1 to 3 percent of the total wall thickness of the pod base.

In another embodiment of the invention, a method of forming a thermoformed plastic beverage pod base configured for use in a single-serve brewing machine wherein the pod base is filled with a beverage extract and sealed with a lid prior to insertion into the machine, the pod base comprising a reduced weight multi-layer wall including:
an outer surface layer of a thermal formable polymer,
an inner surface layer of a thermal formable polymer,
a first interior layer, disposed between the surface layers, of a barrier material,
a second interior layer, disposed between the surface layers, of a foamed regrind material, and
a third interior layer comprising a protective layer disposed between and separating the barrier material layer and the foamed regrind material layer,
wherein the method includes the step of:
forming the foamed regrind material from a ground and foamed sheet material used to form prior pod bases having the same multi-layer wall materials.

In another embodiment of the invention, the method further includes adding previously formed pod bases to the forming step.

In another embodiment of the invention:
the outer surface layer of the thermal formable polymer comprises from 10 to 25 percent of the total wall thickness of the pod base,
the inner surface layer of the thermal formable polymer comprises from 10 to 25 percent of the total wall thickness of the pod base,
the first interior layer of the barrier material comprises from 1 to 3 percent of the total wall thickness of the pod base,
the second interior layer of the foamed regrind material comprises from 40 to 60 percent of the total wall thickness of the pod base, and
the third interior layer separating the barrier material layer and the foamed regrind material layer comprises from 1 to 3 percent of the total wall thickness of the pod base.

### BRIEF DESCRIPTION OF THE DRAWINGS

FIG. 1 is a front perspective view of one embodiment of a single-serve brewing machine that uses pods for brewing a single serving of a hot beverage, and that can be used with the pod of the present invention.

FIG. 2 is another view of the machine of FIG. 1, with the top lid opened, showing placement of the pod in the machine.

FIG. 3 is a view of a pod base during the filling process, wherein a filter and coffee grounds (inside the filter) are inserted into the pod base, followed by sealing the open top end of the pod base with a metal foil lid creating a pod for brewing a single cup serving size.

FIG. 4 is a sectional view of a filled and sealed pod, showing top and bottom hollow needles that puncture the top lid and bottom wall of the pod base, respectively, during use in the machine.

FIG. 5 is a sectional, schematic view of a single-serve machine and pod in use, for delivering a single serving of a beverage to a cup.

FIG. 6 shows a pod base made from a multi-layer film according to one embodiment of the present invention.

FIG. 7 show partial enlarged cross-sectional views through the wall of the pod base, showing various layers of the film wall according to one embodiment of the invention.

FIG. 8 illustrates one embodiment of a method of forming the multi-layer pod base including steps of grinding and foaming previous multi-layer material (for making the pod bases) to make a foamed regrind material and then forming a multi-layer sheet (for forming subsequent pod bases) including the foamed regrind material.

### DETAILED DESCRIPTION

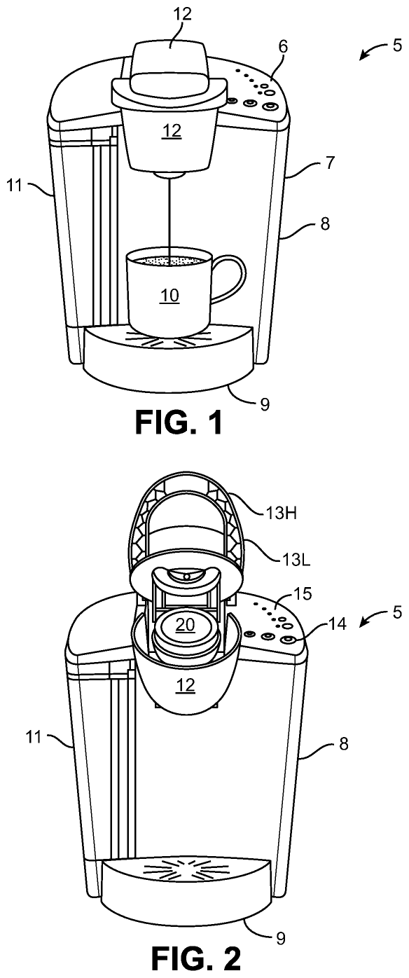

FIGS. 1-5 illustrate one embodiment of a single-serve brewing machine for use with the beverage pod base of the present invention. The invention is not limited to the use of any particular single-serve brewing machine, but rather is directed to the structure of the pod base itself.

The machine and pod may be configured for use with various beverages, such as for example, coffee, tea, hot chocolate or cappuccino. The present embodiment will be directed to use with coffee grounds as the beverage extract and coffee as the brewed beverage.

The pod base of the present invention is intended for use one time, for delivering a single serving, and is thereafter discarded (which may include recycling).

After insertion and filling with a beverage extract, the pod base is designed to be sealed with a lid about a perimeter of an open top end of the base sidewall. Typically, the lid includes a metal foil layer and a heat-sealing layer (for attaching to the open top end of the base). The lid may further include a layer for printing text or graphics (e.g., regarding the product source or other product information).

In the accompanying FIGS. 1-5, a single-serve pod style brewing machine 5 is shown that includes an outer structural housing 6 defining a closed curved rear wall 7 forming an enclosure with an open front face 8, a bottom tray 9 for receiving a beverage cup 10, a water chamber 11 at one side of the outer housing 6, and an upper enclosure (pod housing 12H) having a lid 13L for receiving a pod 20. The outer structural housing 6 further includes controls 14 on an upper portion 15 of the housing. Typically, the water chamber 11 holds enough liquid (here water 26) for multiple beverage servings, such that the user does not need to refill the water chamber after each serving. A new pod 20 is inserted in the machine for each serving.

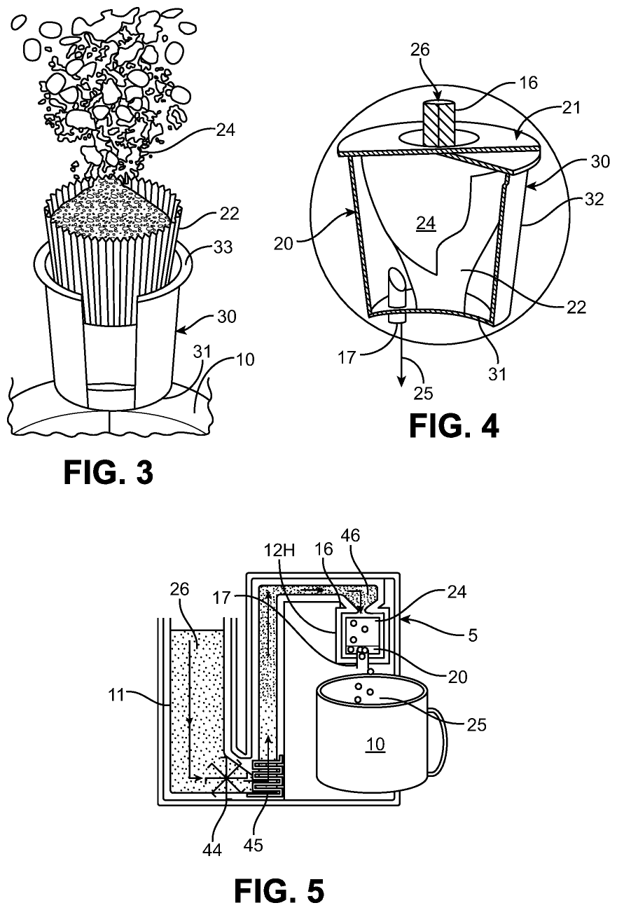

As shown in FIG. 2, the upper pod housing 12H has a movable lid 13L with a handle 13H for opening and closing the pod housing 12H. When lifted, a pod 20 is inserted into the pod chamber 12C (within the pod housing 12H). Prior to insertion into the machine, a filter 22 and beverage extract 24 (here coffee grounds for a single serving) are inserted into the interior of the pod base 30 (as shown in FIG. 3), and a lid 21 is sealed over the top end 33 of the filled pod base 30. Upon closing of the machine lid 13L, the lid 21 of the pod 20 is punctured by the hollow inlet needle 16 that emits heated liquid (water 26) into the internal chamber of the pod (into the top end of the filter containing the coffee grounds), and the bottom wall 31 of the pod base 30 is punctured by the hollow outlet needle 17 that releases the brewed beverage 25, here coffee, out the bottom end of the pod into the beverage cup 10 (as shown in FIGS. 4-5). In other embodiments, a filter is not required.

FIG. 5 is a schematic view of a brewing machine 5, pod 20 and beverage cup 10 during use. As shown, water 26 from the water chamber 11 is pumped 44 into a heating element 45, and the heated water 26 is then forced up into the pod housing 12H. The heated water is forced through a funnel 46, to increase the water pressure in the pod 20. The coffee extract 24 is brewed in the sealed pod 20, with the brewed coffee 25 being forced through the filter 22 at the bottom end 31 of the pod base 30 and out the lower needle 17 into the user's beverage cup 10. In other embodiments, a filter is not required.

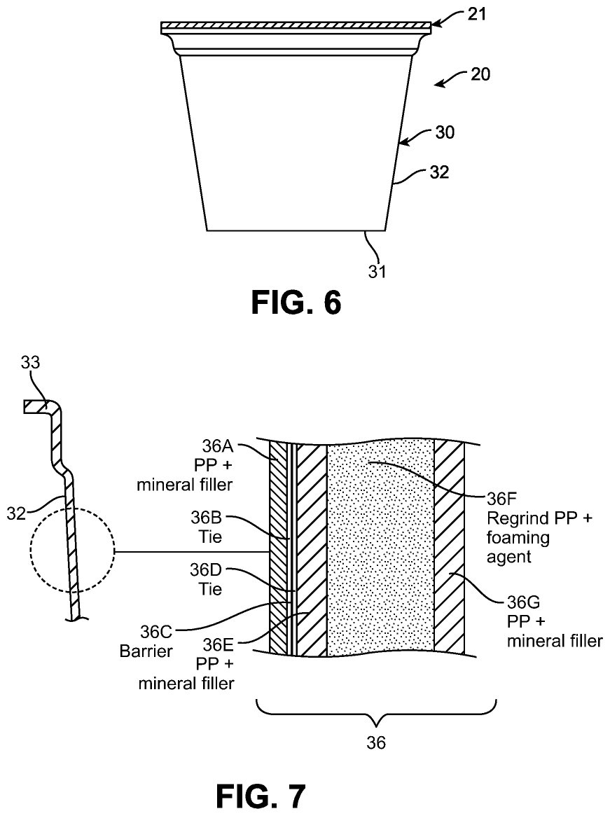

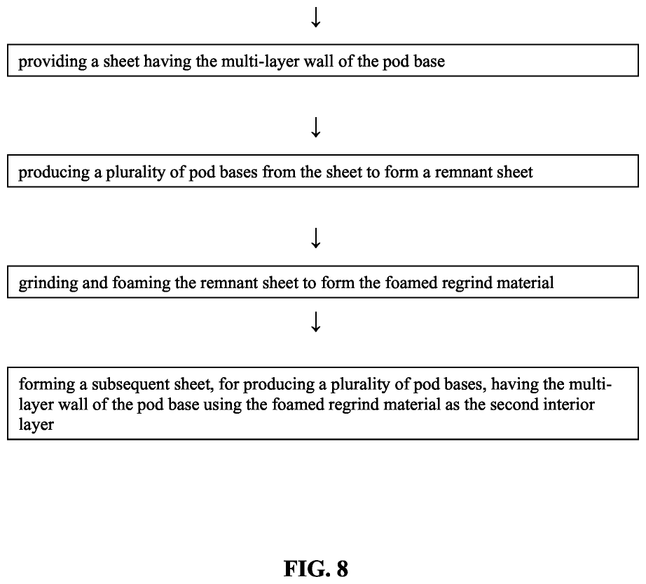

FIG. 6 is front plan view of one embodiment of a pod base 30 according to the present invention, having a closed bottom wall 31, a cylindrical cup-shaped sidewall 32, and an open top end 33. In other embodiments, the pod base may have various other shapes, such as cone shaped, or disk shaped.

FIG. 7 contains two sectional views of the pod base of FIG. 6: on the left, a cross-sectional view of a portion of the sidewall 32 and open top end 33 of the pod base 30, and on the right, an enlarged cross section of the seven-layer pod base wall. In this embodiment, each of the inner and outer surface layers 36A, 36G comprises polypropylene (PP) as the thermal formable polymer, and a mineral filler.

The seven-layer film pod base structure 36 includes in series order:
36A An inner surface layer of PP and mineral filler
36B An interior tie layer
36C An interior barrier layer
36D An interior tie layer
36E An interior layer of PP and mineral filler
36F An interior foamed regrind PP layer
36G An outer surface layer of PP and mineral layer

In various embodiments, the thermal formable polymer of the inner and outer surface layers (and optionally of one or more interior layers as well), may comprise a polyolefin, such as polypropylene or high-density polyethylene, or other polymers such as polyesters (e.g., polyethylene terephthalate) or polystyrene. Other thermal formable polymer layers can be added (as illustrated in the examples below) and optionally can be foamed; however, foaming of the regrind layer is preferred in terms of operational implementation and pod base mechanical performance.

The following three examples illustrate various embodiments with different multi-layer wall structures, including different numbers of layers, materials, and layer thickness percentages. The inner and outer exterior layers, and interior layers as well, may optionally include color if desired (e.g., for aesthetic purposes). In various embodiments, the multi-layer wall of the pod base is formed by thermoforming, and in one embodiment by extruding all layers at one time (simultaneously) using a multi-layer extrusion line.

Example 1

| | Layer |
|---|---|
| | Thickness |
| Standard pod base Layer Structure - 1 | % |
| Thermal formable polymer and Mineral Filler (outer layer) | 10-15% |
| Foamed Regrind (second interior layer) | 40-60% |
| Thermal formable polymer and Mineral Filler (interior layer) | 10-15% |
| Tie Layer (third interior layer) | 1-3% |
| Barrier Layer (first interior barrier layer) | 1-3% |
| Tie Layer (fourth interior layer) | 1-3% |
| Thermal formable polymer and Mineral Filler (inner layer) | 10-15% |

Example 2

| | Layer |
|---|---|
| | Thickness |
| Alternative pod base Layer Structure - 2 | % |
| Thermal formable polymer and Mineral Filler (outer layer) | 10-15% |
| Foamed Regrind (second interior layer) | 20-30% |
| Thermal formable polymer and Mineral Filler (interior layer) | 5-15% |
| Tie Layer (third interior layer) | 1-3% |
| Barrier Layer (first interior barrier layer) | 1-3% |
| Tie Layer (interior layer) | 1-3% |
| Thermal formable polymer and Mineral Filler (interior layer) | 5-15% |
| Foamed Regrind (interior layer) | 20-30% |
| Thermal formable polymer and Mineral Filler (inner layer) | 10-15% |

Example 3

| | Layer |
|---|---|
| | Thickness |
| Alternative pod base Layer Structure - 3 | % |
| Thermal formable polymer and Mineral Filler (outer layer) | 10-25% |
| Foamed Regrind (second interior layer) | 20-30% |
| Tie Layer (third interior layer) | 1-3% |
| Barrier layer (first interior layer) | 1-3% |
| Tie Layer (fourth interior layer) | 1-3% |
| Foamed Regrind (interior layer) | 20-30% |
| Thermal formable polymer and Mineral Filler (inner layer) | 10-25% |

These and other embodiments will be apparent from the disclosure and are included in the scope of the invention as described herein.

1. A thermoformed plastic beverage pod base configured for use in a single-serve brewing machine wherein the pod base is filled with a beverage extract and sealed with a lid prior to insertion into the machine, the pod base comprising a reduced weight multi-layer wall including:
an outer surface layer of a thermal formable polymer,
an inner surface layer of a thermal formable polymer,
a first interior layer, disposed between the surface layers, of a barrier material,
a second interior layer, disposed between the surface layers, of a foamed regrind material, and
a third interior layer comprising a protective layer disposed between and separating the barrier material layer and the foamed regrind material layer,
wherein the foamed regrind material is composed of a ground material comprising the materials of the multi-layer wall of the pod base, which is foamed to reduce the weight of the ground material.

2. The pod base of claim 1, wherein the foamed regrind material is formed by addition of a foaming agent or injection of gas to the ground material.

3. The pod base of claim 1, wherein the second interior layer of foamed regrind material provides a weight reduction of from 5 to 20% compared to a non-foamed regrind material layer having a same layer thickness.

4. The pod base of claim 1, wherein the outer and inner surface layers include a mineral filler that enhances the mechanical properties of the outer and inner surface layers.

5. The pod base of claim 4, wherein the mineral filler and foamed regrind material provide the pod base with a density of less than 1 gram per cubic centimeter.

6. The pod base of claim 1, wherein the thermal formable polymer comprises polyolefin, polyester or polystyrene polymer.

7. The pod base of claim 6, wherein the polyolefin polymer comprises polypropylene or high-density polyethylene.

8. The pod base of claim 1, wherein the thermal formable polymer comprises polypropylene.

9. The pod base of claim 4, wherein the mineral filler comprises at least one of talc and calcium carbonate.

10. The pod base of claim 1, wherein the barrier material is an oxygen barrier material.

11. The pod base of claim 10, wherein the oxygen barrier material comprises ethylene vinyl alcohol (EVOH).

12. The pod base of claim 1, wherein the multi-layer wall includes:
a fourth interior layer disposed between and separating the second interior layer and one of the outer or inner surface layers.

13. The pod base of claim 12, wherein the third and fourth interior layers are tie layers.

14. A method of forming a thermoformed plastic beverage pod base configured for use in a single-serve brewing machine wherein the pod base is filled with a beverage extract and sealed with a lid prior to insertion into the machine, the pod base comprising a reduced weight multi-layer wall including:
an outer surface layer of a thermal formable polymer,
an inner surface layer of a thermal formable polymer,
a first interior layer, disposed between the surface layers, of a barrier material,
a second interior layer, disposed between the surface layers, of a foamed regrind material, and
a third interior layer comprising a protective layer disposed between and separating the barrier material layer and the foamed regrind material layer,
wherein the method includes steps of:
providing a sheet having the multi-layer wall of the pod base,
producing a plurality of pod bases from the sheet to form a remnant sheet,
grinding and foaming the remnant sheet to form the foamed regrind material, and
forming a subsequent sheet, for producing a plurality of pod bases, having the multi-layer wall of the pod base using the foamed regrind material as the second interior layer.

15. The method of claim 14, wherein the method includes adding previously formed pod bases having the multi-layer wall to the grinding and foaming step.

16. The pod base of claim 1, wherein:
the outer surface layer of the thermal formable polymer comprises from 10 to 25 percent of the total wall thickness of the pod base,
the inner surface layer of the thermal formable polymer comprises from 10 to 25 percent of the total wall thickness of the pod base,
the first interior layer of the barrier material comprises from 1 to 3 percent of the total wall thickness of the pod base,
the second interior layer of the foamed regrind material comprises from 40 to 60 percent of the total wall thickness of the pod base, and
the third interior layer separating the barrier material layer and the foamed regrind material layer comprises from 1 to 3 percent of the total wall thickness of the pod base.

17. A method of forming a thermoformed plastic beverage pod base configured for use in a single-serve brewing machine wherein the pod base is filled with a beverage extract and sealed with a lid prior to insertion into the machine, the pod base comprising a reduced weight multi-layer wall including:
an outer surface layer of a thermal formable polymer,
an inner surface layer of a thermal formable polymer,
a first interior layer, disposed between the surface layers, of a barrier material,
a second interior layer, disposed between the surface layers, of a foamed regrind material, and
a third interior layer comprising a protective layer disposed between and separating the barrier material layer and the foamed regrind material layer,
wherein the method includes the step of:
forming the foamed regrind material from a ground and foamed sheet material used to form prior pod bases having the same multi-layer wall materials.

18. The method of claim 17, wherein the method further includes adding previously formed pod bases to the forming step.

19. The method of claim 17, wherein:
the outer surface layer of the thermal formable polymer comprises from 10 to 25 percent of the total wall thickness of the pod base,
the inner surface layer of the thermal formable polymer comprises from 10 to 25 percent of the total wall thickness of the pod base,
the first interior layer of the barrier material comprises from 1 to 3 percent of the total wall thickness of the pod base,
the second interior layer of the foamed regrind material comprises from 40 to 60 percent of the total wall thickness of the pod base, and
the third interior layer separating the barrier material layer and the foamed regrind material layer comprises from 1 to 3 percent of the total wall thickness of the pod base.
